(19) United States
(12) Patent Application Publication
(10) Pub. No.: US 2005/0137342 A1
(43) Pub. Date: Jun. 23, 2005

(54) Polyethylene blend films

(76) Inventors: Rajendra K. Krishnaswamy, Bartlesville, OK (US); Ashish M. Sukhadia, Bartlesville, OK (US)

Correspondence Address: WILLIAMS, MORGAN & AMERSON, P.C., 10333 RICHMOND, SUITE 1100, HOUSTON, TX, 77042, US

(21) Appl. No.: 10/742,603

(22) Filed: Dec. 19, 2003

(51) Int. Cl. C08L 23/00

(52) U.S. Cl. 525/240

(57) ABSTRACT

Compositions and methods are described herein for use in packaging having improved moisture vapor barrier properties. Compositions of the present invention can comprise between about 1 wt % and 30 wt % of a low molecular weight high density polyethylene and between about 99 wt % and 70 wt % of a higher molecular weight high density polyethylene. The low molecular weight high density polyethylene can have a weight-average molecular weight between about 1,000 g/mol and 100,000 g/mol. The higher molecular weight high density polyethylene can have a weight-average molecular weight of between about 50,000 g/mol and 500,000 g/mol that is higher than the weight-average molecular weight of the low molecular weight high density polyethylene. The compositions can have a normalized MVTR less than about 0.41 g/in²·day·mil.

### BACKGROUND OF THE INVENTION

Polyethylenes can be used in the manufacture of a number of different packaging items using a variety of conversion processes such as blow molding, injection molding, sheet extrusion, blown film extrusion and cast film extrusion. Polyethylenes can also be used as components in multilayer packaging articles, which are manufactured using coextruded blown film, coextruded cast film, coextruded blow molding and other processes such as extrusion coating and laminations. Through the use of these various processing techniques, polyethylenes can be used to package a number of different food and non-food finished goods such as milk (e.g., blow molded bottles), bread (e.g., blown and cast films), paper products (e.g., extrusion coating, cast and blown film), applesauce (thermoformed sheet) and cleaning supplies (e.g., injection and blow molded bottles).

Polyethylenes with densities higher than about 0.940 g/cm³ are typically referred to as high density polyethylenes (HDPEs). These can be produced with no comonomer or with very small amounts of comonomers such as α-olefins like hexene, butene, and octane, among others. HDPE are typically produced in slurry loop reactors, solution form reactors or in gas phase fluidized bed reactors.

High density polyethylenes are used in packaging items because they provide at least some resistance to moisture, gases, acids, bases, and solvents, while retaining package integrity by virtue of their impact strength, tear strength, stiffness, and other key attributes or properties. While certain high density polyethylenes can have relatively low moisture vapor transmission rates, there are other polymers with still lower moisture transmission rates than high density polyethylenes. Thus, it could be advantageous to produce packaging items comprising high density polyethylene with improved moisture barrier properties, while minimizing any increase in manufacturing cost or significantly decreasing other desirable properties imparted by high density polyethylene to the packaging item.

### SUMMARY OF THE INVENTION

The present invention relates generally to the field of packaging materials, particularly packaging materials for use with moisture sensitive products. It concerns improving moisture vapor barrier properties of certain high density polyethylene resins by blending them with lower molecular weight high density polyethylene resins.

One aspect of the present invention is a composition that comprises between about 1 wt % and 30 wt % of a low molecular weight high density polyethylene (low molecular weight HDPE) and between about 99 wt % and 70 wt % of a higher molecular weight high density polyethylene (higher molecular weight HDPE). The low molecular weight HDPE can have a weight-average molecular weight between about 1,000 g/mol and 100,000 g/mol. The higher molecular weight HDPE can have a weight-average molecular weight (1) that is higher than the weight-average molecular weight of the low molecular weight HDPE and (2) that is between about 50,000 g/mol and 500,000 g/mol. The composition can have a MVTR of less than about 0.41 g/100in²·day·mil. In some aspects of the invention the composition can have an MVTR that is less than about 0.37 g/100in²·day·mil or less than about 0.33 g/100in²·day·mil. Certain such compositions can have lower normalized moisture vapor transmission rates after processing than the higher molecular weight HDPE (e.g., without a low molecular weight HDPE added) that has been prepared under similar or equivalent extrusion conditions, and they have a similar extruded thickness.

In certain aspects of the invention, the composition consists essentially of the low molecular weight HDPE and the higher molecular weight HDPE. In some aspects of the invention, the composition also comprises at least one antioxidant. In some aspects of the invention, the composition consists essentially of the at least one antioxidant, the low molecular weight HDPE, and the higher molecular weight HDPE.

In some aspects of the invention, the low molecular weight HDPE can have a melt index of between about 1 dg/min and 100 dg/min. The low molecular weight HDPE can have a density that can be less than or equal to the density of the higher molecular weight HDPE in certain aspects of the invention. In some aspects of the invention, the composition can be incorporated in or coated onto a packaging article.

Another aspect of the present invention is a method of preparing a moisture vapor resistant composition, as described above, and some another aspect can be to a packaging article comprising at least one layer comprising between about 1 wt % and 30 wt % of a low molecular weight HDPE and between about 99 wt % and 70 wt % of a higher molecular weight HDPE. The low molecular weight HDPE can have a weight-average molecular weight between about 1,000 g/mol and 100,000 g/mol. The higher molecular weight HDPE molecular weight can have (1) a higher weight-average molecular than the weight-average molecular weight of the low molecular weight HDPE, and (2) the weight-average molecular weight can be between about 50,000 g/mol and 500,000 g/mol. The composition prepared by the method can have a MVTR of less than about 0.41 g/100 in²·day·mil. In some aspects of the invention, the MVTR of the composition can be less than about 0.37 g/100 in²·day·mil or less than about 0.33 g/100 in²·day·mil. In certain aspects of the present invention, the packaging article can be, but is not limited to, a film. In some aspects of the invention, a film of the present invention can have a normalized moisture vapor transmission rate (MVTR) of less than about 0.41 g/100 inch²·day·mil.

Compositions of the present invention can be incorporated into packaging articles by extruding the composition, by coextruding the composition with other resins to produce a packaging article, by coating the surface of a packaging article with the composition, or by laminating a film comprising the composition to the surface(s) of a packaging article, among others. Blending of a low molecular weight HDPE with polyethylene can in certain cases result in a lower MVTR for the blended composition than for the higher molecular weight HDPE alone. Certain compositions of the present invention can be used in producing packaging articles, including, but not limited to, blow molded containers (e.g. milk bottles and juice bottles), injection molded articles, coatings, laminates, lightweight consumer bags, thermoformed containers from extruded sheets, and various cast, and blown packaging films. The packaging articles can be produced by any method known in the art.

Compositions of the present invention used in packaging may have fewer negative organoleptic effects on packaged products than some polyethylene blends comprising certain low molecular weight hydrocarbon resins, especially unhydrogenated hydrocarbon resins. For example, compositions of the present invention can have characteristics that should allow them to be approved for food packaging uses.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific aspects presented herein.

FIG. 1 is a schematic representation of a five-layer packaging article.

FIG. 2 is a schematic representation of a three-layer packaging article.

### DESCRIPTION OF ILLUSTRATIVE EMBODIMENTS

One aspect of the present invention is directed to a moisture resistant composition that comprises between about 1 wt % and 30 wt % of a low molecular weight high density polyethylene (low molecular weight HDPE) and between about 99 wt % and 70 wt % of a higher molecular weight high density polyethylene (higher molecular weight HDPE). The low molecular weight HDPE can have a weight-average molecular weight of between about 1,000 g/mol and 100,000 g/mol. The higher molecular weight HDPE can have a weight-average molecular weight (1) that is higher than the weight-average molecular weight of the low molecular weight HDPE and (2) that is between about 50,000 g/mol and 500,000 g/mol. The composition can have a MVTR of less than about 0.41 g/100in²·day·mil. In some aspects of the invention, the composition can have an MVTR that is less than about 0.37 g/100in2·day·mil or less than about 0.33 g/100in²·day·mil. Such compositions may, in certain aspects, have lower normalized moisture vapor transmission rates after processing than the higher molecular weight HDPE (e.g., without a low molecular weight HDPE added) that has been prepared under similar or equivalent extrusion conditions, and they have a similar extruded thickness.

In certain aspects of the invention the composition consists essentially of the low molecular weight HDPE and the higher molecular weight HDPE. In some aspects of the invention the composition further comprises at least one of: at least one antioxidant, at least one UV-protectant material, at least one antifogging agent, or combinations thereof. In certain aspects of the invention the composition consists essentially of at least one antioxidant, the low molecular weight HDPE, and the higher molecular weight HDPE.

In certain aspects of the invention, the moisture resistant composition comprises between about 1 wt % and 20 wt % of the low molecular weight HDPE, and in some aspects it comprises between about 10 wt % and 20 wt % of the low molecular weight HDPE. In some aspects of the invention, the low molecular weight HDPE can have a weight-average molecular weight of between about 1,000 g/mol and 60,000 g/mol, and some aspects of the invention, the low molecular weight HDPE can have a weight-average molecular weight of between about 10,000 g/mol and 60,000 g/mol.

In certain aspects of the present invention, the low molecular weight HDPE can have a melt index of between about 1 dg/min and 100 dg/min. In some aspects of the invention the low molecular weight HDPE can have a melt index of between about 5 dg/min and 50 dg/min, and in certain aspects the low molecular weight HDPE can have a melt index of between about 5dg/min and 30 dg/min The higher molecular weight HDPE of compositions of the present invention can have a higher weight-average molecular weight than the low molecular weight HDPE and the weight-average molecular weight can be between about 50,000 g/mol and 500,000 g/mol. In certain aspects of the invention, the higher molecular weight HDPE can have a weight-average molecular weight of between about 50,000 g/mol and 350,000 g/mol, and in some aspects of the invention it can be between about 50,000 g/mol and 200,000 g/mol.

The low molecular weight HDPE can have a density that can be greater than or equal to the density of the higher molecular weight HDPE, in certain aspects of the invention. The higher molecular weight HDPE can have a density of between about 0.94 g/cm³ and 0.97 g/cm³. In some aspects of the invention, the higher molecular weight HDPE can have a density of between 0.94 g/cm³ and 0.965 g/cm³. In certain aspects of the invention, the low molecular weight HDPE can have a density of between about 0.945 g/cm³ and 0.975 g/cm³. In certain aspects of the invention, the low molecular weight HDPE can have a zero-shear viscosity that can be less than or equal to about 0.9 times the zero-shear viscosity of the higher molecular weight HDPE.

In certain aspects of the present invention, moisture resistant compositions of the present invention comprise at least one primary antioxidant along with the higher molecular weight HDPE and the low molecular weight HDPE. The primary antioxidant can aid in maintaining the properties of the polymer during processing and can be a primary antioxidant known in the art, including, but not limited to a phenolic antioxidant. In some aspects the composition comprises at least about 100 ppm of the primary antioxidant. In certain aspects of the invention, the composition comprises both a primary antioxidant and a secondary antioxidant. The secondary antioxidant can be a secondary antioxidant known in the art, including, but not limited to a phosphite antioxidant. For example, Irganox 1076 (n-octadecyl 3-(3,5-di-t-butyl-4-hydroxyphenyl propionate, Ciba) can be used as a primary antioxidant and Irgafos 168 (Tris(2,4-ditert-butylphenyl)phosphite, Ciba) can be used as a secondary antioxidant among others, in certain aspects of the present invention. Compositions of the present invention can also comprise other additives known in the art, including, but not limited to UV protectant materials and antifogging agents, among others.

Some aspects of the invention are directed to a packaging article comprising at least one layer comprising between about 1 wt % and 30 wt % of a low molecular weight HDPE and between about 99 wt % and 70 wt % of a higher molecular weight HDPE. The low molecular weight HDPE can have a weight-average molecular weight between about 1,000 g/mol and 100,000 g/mol. The higher molecular weight HDPE molecular weight HDPE can have a higher weight-average molecular than the weight-average molecular weight of the low molecular weight HDPE, and the weight-average molecular weight can be between about 50,000 g/mol and 500,000 g/mol. The layer can be as described above for the composition of the present invention. In certain aspects of the invention, the packaging article can be a film. In some aspects of the invention, a film of the present invention can have a normalized moisture vapor transmission rate (MVTR also referred to as water vapor transmission rate (WVTR)) of less than about 0.41 g/100 inch²·day·mil. In certain aspects of the invention, a film of the present invention can have a normalized MVTR of less than about 0.37 g/100 inch²·day·mil or 0.33 g/100 inch²·day·mil.

In some aspects of the present invention the moisture resistant composition of the present invention can be incorporated in or coated onto a packaging article. The compositions can be incorporated into packaging articles by extruding the composition, by coextruding the composition with other resins to produce a packaging article, by coating the surface of a packaging article with the composition, or by laminating a film comprising the composition to the surface(s) of a packaging article, among others. Blending of a low wt % of a low molecular weight HDPE with a higher molecular weight polyethylene can in certain cases result in a lower MVTR for the blended composition than for the higher molecular weight polyethylene alone. Certain compositions of the present invention can be used in producing packaging articles, including, but not limited to blow molded containers (e.g. milk bottles and juice bottles), injection molded articles, coatings, lightweight consumer bags, thermoformed containers from extruded sheets, and various cast, and blown packaging films.

The HDPE (both low molecular weight and higher molecular weight) used in compositions of the present invention can be a linear homopolymer of ethylene, but in some cases the linear polymer can comprise monomers other than those derived from ethylene, including but not limited to hexene, butene, and octene, among others. Such monomers can be added in an amount to adjust the density of the HDPE. In certain aspects of the invention the low molecular weight HDPE and the higher molecular weight HDPE can have a density of between about 0.94 g/cc and 0.97 g/cc or between about 0.955 and 0.966 g/cc. In general, density correlates to the crystallinity of the HDPE material, in other words, the higher the density of the HDPE, the higher the degree of crystallinity in the material. In certain cases HDPEs comprising monomers other than ethylene will be less crystalline. The melt index of the compositions of the present invention can depend on the process in which the composition is to be used. The melt index can be between about 0.3 dg/min and 7 dg/min for blown film, between about 1 dg/min and 20 dg/min for cast film, between about 1 dg/min and 100 dg/min for injection and blow molding, and between about 1 dg/min and 20 dg/min for coatings.

A low molecular weight HDPE can be used in certain aspects of the present invention, and the low molecular weight HDPE can have a zero-shear viscosity that is less than or equal to 0.9 times the zero-shear viscosity of the higher molecular weight HDPE. The higher molecular weight HDPE can have a melt index of between about 0.3 dg/min and 100 dg/min. The pellet density of the low molecular weight HDPE can be at least about 0.950 g/cm³ at 23° C., or between about 0.950 and 0.977 g/ cm³. The zero-shear viscosity (low-shear rate or low-frequency Newtonian limit) of the polymer can be obtained from dynamic mechanical measurements (torsional rheology) performed at 190° C. An example of a suitable low molecular weight HDPE includes, but is not limited to HiD 9608 or M656 (Chevron Phillips Chemical Co.). HiD 9608 has a melt index of about 8.0 dg/min and its density is about 0.962 g/cc. An example of a suitable higher molecular weight HDPE is D449CP, among others.

Certain aspects of the invention are directed to methods of preparing a moisture vapor resistant composition, as described above, comprising blending a higher molecular weight HDPE with a low molecular weight HDPE. The blend comprises between about 1 wt % and 30 wt % of the low molecular weight HDPE resin and between about 70 wt % and 99 wt % of the higher molecular weight HDPE. The blend can be as described above for the composition. The method can comprise blending at least one antioxidant, as described above, with the higher molecular weight HDPE and the low molecular weight HDPE.

The blending can be done using methods known in the art, for example the higher molecular weight HDPE and the low molecular weight HDPE can be melt blended (e.g., compounded) or dry blended, among others. In certain aspects of the invention, the method can further comprise blends being coextruded with other resins or extruded, or the blend can be incorporated in a packaging article (e.g. laminating a film comprising the composition to a packaging article or coating the blend onto the surface of a packaging article, among others). Extrusion, coextrusion and incorporation of the blend into packaging articles can be performed using methods known in the art.

Yet another aspect of the present invention is directed to a packaging article, comprising at least one layer that comprises between about 1 wt % and 30 wt % of a low molecular weight HDPE and between about 70 wt % and 99 wt % of a higher molecular weight HDPE (e.g., a composition of the present invention). The layer can be as described above for the composition. The packaging article can be a film, including, but not limited to a cast film or a blown film. In certain aspects of the invention, the packaging article can have from 2 to 7 layers, but the packaging article can comprise more layers.

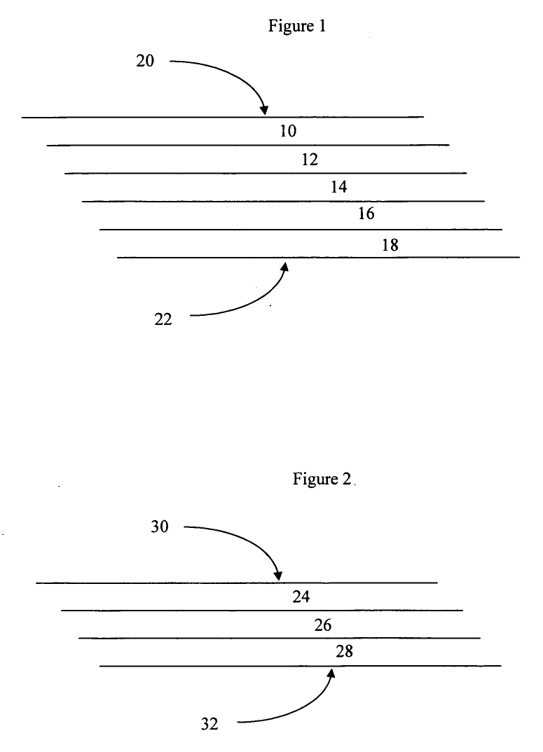

Certain aspects of the present invention can be better understood by reference to FIGS. 1 and 2. Two different film constructions are shown in the figures. FIG. 1 is a five-layer moisture vapor barrier film construction. FIG. 2 is a three-layer moisture vapor barrier film. Films generally have between 2 and 7 layers, though three and five layer films are depicted in FIGS. 1 and 2. Methods known in the art can be used to form multi-layered films as depicted in FIGS. 1 and 2. Such three and five layer constructions can, for example, be made by coextrusion and used in packaging for moisture vapor sensitive foods. In FIG. 1, the interior surface of the film 20 is closest to the product to be packaged. The exterior surface of the film 22 is exposed to the external environment. At least one of the five layers of the film (the most exterior layer 18 (e.g., skin layer), the core layers 12, 14 and 16, or the most interior layer 10) comprises between about 1 wt % and 30 wt % of a low molecular weight HDPE and between about 70 wt % and 99 wt % of a higher molecular weight HDPE. In some aspects of the invention, layer 18 can be about 10% to 20% of the total thickness, layers 12, 14 and 16 combined can be about 60% to 80% of the thickness, and layer 10 can be about 10% to 20% of the thickness of the product film. For example, layer 10 can be a sealant material, layers 14, 16, and 18 can be HDPE with a melt index of less than 1.5 g/10 min and layer 12 can comprise about 30 wt % of a low molecular weight HDPE and about 70 wt % of a higher molecular weight HDPE (e.g., a composition of the present invention).

Similarly, in FIG. 2, the interior surface of the film 30 is closest to the product to be packaged. The exterior surface of the film 32 is exposed to the external environment. At least one of the three layers of the film (the most exterior layer 28 (e.g., skin layer), the core layer 26, or the most interior layer 24 (e.g., seal layer) comprises between about 1 wt and 30 wt % of a low molecular weight HDPE and between about 70 wt % and 99 wt % of a higher molecular weight HDPE (e.g., a composition of the present invention). In some aspects of the invention, layer 28 can be about 10% to 20% of the total thickness, layer 26 may be about 60% to 80% of the thickness, and layer 24 can be about 10% to 20% of the thickness of the product film. For example, layer 24 can be a sealant material, layer 26 can comprise about 30 wt % of a low molecular weight HDPE and about 70 wt % of a higher molecular weight HDPE (e.g., a composition of the present invention), and layer 28 can comprise a HDPE resin with a melt index of about 1.0 g/10 min.

Compositions of the present invention can also be used in producing a monolayer film. Commercial viability of monolayer applications is generally dependent on the heat sealing qualities of the polyethylene (PE) blend. Compositions of the present invention that are monolayer films can be laminated to other films or paper to make a packaging article with improved barrier properties.

One advantage of compositions of the present invention can be that they can be advantageously used to form film of relatively low normalized MVTR. Further, the compositions of the present invention can be advantageous in that the same composition can be used for the skin layer (e.g. 18 in FIG. 1 and 28 in FIG. 2) of the coextruded construction and at least one core layer. Prior to this work, some constructions being produced for their moisture vapor barrier properties had a higher melt index HDPE resin as the skin layer of the construction and a lower melt index HDPE resin as a core layer or layers in order to achieve improved moisture vapor barrier properties than a film using the lower melt index HDPE in both the skin and core layers.

Five-layer constructions (similar to FIG. 1) have been made with a skin layer or outside layer 18 of the film with HDPE having a higher melt index. The three core layers, 12, 14 and 16 in FIG. 1, generally consisting of a HDPE having a lower melt index. As mentioned above, layer 10 in FIG. 1 is the seal layer in the coextruded construction. Resins used in the seal layer 10 generally demonstrate a low crystallinity and as such do not appreciably contribute to the MVTR performance of the film.

As is the case in the five-layer construction, a typical three-layer construction (similar to FIG. 2) can comprise a higher melt index HDPE layer, as the skin layer 28. The core layer 26 in the three-layer construction generally comprises a HDPE having a lower melt index. The seal layer 24 in the three-layer construction comprises a sealant material.

Compositions of the present invention can be used for both the skin layer 28 and core layer 26 of the three-layer construction (FIG. 2) and in layers 18, 16, 14 and 12 of the five-layer construction (FIG. 1) to achieve substantially equivalent barrier properties to the conventional systems requiring different grades of HDPE in the skin and core layer(s). Using the same composition in two layers can be attractive for film manufacturers for convenience in both production of film and the inventory of resin. Since compositions of the present invention can eliminate the need for a separate skin and core layer resin, film processors can reduce the number of resins they must inventory and the need for tracking two different resins within the transfer systems of the plant may be eliminated.

The following examples are included to demonstrate embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

Moisture vapor transmission rates in Table 1 below were obtained from blown films processed under the following conditions: 1.5 inch Davis Standard Extruder; 4 inch Sano film die with dual lip air ring; 0.060 inch die gap; 2.5:1 blow-up ratio; extruder (barrel) and die set temperature 190° C.; 55 lb/hr extrusion rate; and 0.8 mil film thickness. All Theological tests were carried out in a Rheometrics ARES rheometer using parallel plate geometry at 190° C. Dynamic oscillatory measurements were performed and the resulting complex viscosity versus frequency data (|η*| vs. ω) were fitted to the Carreau-Yasuda [CY] equation, which is shown below:

$$\vert {η}^{*} ( ω ) \vert = η ( γ ) = \frac{{η}_{0}}{{[ 1 + {( {τ}_{η} ω )}^{a} ]}^{( 1 - n ) / a}}$$

η₀ is the zero-shear viscosity (low-frequency limit or Newtonian viscosity), τ_{η} is the viscous relaxation time, α is an inverse breadth parameter (describes the distribution of melt relaxation times), and n is the limiting power law behavior of the viscosity at high shear rates.

The HDPE-A (higher molecular weight HDPE) of the binary blend was Chevron Phillips Chemical HiD 9662, which has density of 0.962 g/cm³ and a melt index of 1.05 g/10 min. The LMW-HDPE-1 (low molecular weight HDPE) was Chevron Phillips Chemical HiD 9608, which has a density of 0.962 g/cm³ and a melt index of 8.0 g/10 min.

TABLE 1

| | | Zero-Shear | Melt |
|---|---|---|---|
| Blend Ratio | | Viscosity | Relaxation |
| HDPE-A/ | MVTR | {η₀} | Time |
| LMW-HDPE-1 | (g/100 inch² · day · mil) | (Pa · s) | (s) |
| 100/0 | 0.47 | 56400 | 0.15 |
| 99/1 | 0.41 | 52900 | 0.14 |
| 97/3 | 0.40 | 52100 | 0.12 |
| 95/5 | 0.40 | 48400 | 0.11 |
| 90/10 | 0.37 | 41600 | 0.09 |
| 80/20 | 0.34 | 30700 | 0.05 |
| 70/30 | 0.33 | 22200 | 0.03 |
| 0/100 | — | 1210 | 0.005 |

A 15% improvement in moisture vapor transmission rate MVTR with 5 wt % low molecular weight HDPE in the blend film was noted, a 21% improvement in MVTR with 10 wt % low molecular weight HDPE in the blend film, and a 28% improvement in MVTR with 20 wt % low molecular weight HDPE in the blend film.

All of the compositions and methods disclosed and claimed herein can be made and executed without undue experimentation in light of the present disclosure. While the compositions and methods of this invention have been described herein, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

1. A composition, comprising:
between about 1 wt % and 30 wt % of a low molecular weight high density polyethylene and between about 99 wt % and 70 wt % of a higher molecular weight high density polyethylene, wherein the low molecular weight high density polyethylene has a weight-average molecular weight between about 1,000 g/mol and 100,000 g/mol, and the higher molecular weight high density polyethylene has a weight-average molecular weight (1) that is between about 50,000 g/mol and 500,000 g/mol and (2) that is higher than the weight-average molecular weight of the low molecular weight high density polyethylene, wherein the composition has a normalized MVTR of less than about 0.41 g/100 in²·day·mil.

2. The composition of claim 1, wherein the composition has a normalized MVTR of less than about 0.37 g/100 in2·day·mil.

3. The composition of claim 1, wherein the composition has a normalized MVTR of less than about 0.33 g/100in²·day·mil.

4. The composition of claim 1, wherein the composition consists essentially of the low molecular weight high density polyethylene and the higher molecular weight high density polyethylene.

5. The composition of claim 1, wherein the composition further comprises at least one antioxidant, and consists essentially of the at least one antioxidant, the low molecular weight high density polyethylene, and the higher molecular weight high density polyethylene.

6. The composition of claim 1, wherein the composition comprises between about 1 wt % and 20 wt % of the low molecular weight high density polyethylene.

7. The composition of claim 1, wherein the composition comprises between about 10 wt % and 20 wt % of the low molecular weight high density polyethylene.

8. The composition of claim 1, wherein the low molecular weight high density polyethylene has a weight-average molecular weight of between about 1,000 g/mol and 60,000 g/mol.

9. The composition of claim 1, wherein the low molecular weight high density polyethylene has a weight-average molecular weight of between about 10,000 g/mol and 60,000 g/mol.

10. The composition of claim 1, wherein the low molecular weight high density polyethylene has a melt index of between about 1 dg/min and 100 dg/min.

11. The composition of claim 1, wherein the low molecular weight high density polyethylene has a melt index of between about 5 dg/min and 50 dg/min.

12. The composition of claim 1, wherein the low molecular weight high density polyethylene has a melt index of between about 5 dg/min and 30 dg/min.

13. The composition of claim 1, wherein the low molecular weight high density polyethylene has a density that is greater than or equal to the density of the higher molecular weight high density polyethylene.

14. The composition of claim 1, wherein the low molecular weight high density polyethylene has a zero-shear viscosity that is less than or equal to about 0.9 times the zero-shear viscosity of the higher molecular weight high density polyethylene.

15. The composition of claim 1, wherein the higher molecular weight high density polyethylene has a density of between about 0.94 g/cc and 0.97 g/cc.

16. The composition of claim 1, wherein the higher molecular weight high density polyethylene has a weight-average molecular weight of between about 50,000 g/mol and 350,000 g/mol.

17. The composition of claim 1, wherein the higher molecular weight high density polyethylene has a weight-average molecular weight of between about 50,000 g/mol and 200,000 g/mol.

18. The composition of claim 1, wherein the composition comprises at least about 100 ppm of at least one primary antioxidant.

19. The composition of claim 18, wherein the composition further comprises at least one secondary antioxidant.

20. The composition of claim 1, wherein the composition is incorporated in or coated onto a packaging article.

21. A method of preparing a moisture vapor resistant composition, comprising:
blending a higher molecular weight high density polyethylene with a low molecular weight high density polyethylene, wherein the blend comprises between about 1 wt % and 30 wt % of the low molecular weight high density polyethylene and between about 99 wt % and 70 wt % of the higher molecular weight high density polyethylene, wherein the low molecular weight high density polyethylene has a weight-average molecular weight of between about 1,000 g/mol and 100,000 g/mol, and the higher molecular weight high density polyethylene has a weight-average molecular weight (1) that is between about 50,000 g/mol and 500,000 g/mol and (2) that is higher than the weight-average molecular weight of the low molecular weight high density polyethylene, wherein the blend has a normalized MVTR of less than about 0.41 g/100 in²·day·mil.

22. The method of claim 21, wherein the blend has a normalized MVTR of less than about 0.37 g/100in²·day·min.

23. The method of claim 21, wherein the blend has a normalized MVTR of less than about 0.33 g/100 in²·day·mil.

24. The method of claim 21, wherein the blend consists essentially of the low molecular weight high density polyethylene and the higher molecular weight high density polyethylene.

25. The method of claim 21, wherein the blend consists essentially of at least one antioxidant, the low molecular weight high density polyethylene, and the higher molecular weight high density polyethylene.

26. The method of claim 21, wherein the blend comprises between about 1 wt % and 20 wt % of the low molecular weight high density polyethylene.

27. The method of claim 21, wherein the blend comprises between about 10 wt % and 20 wt % of the low molecular weight high density polyethylene.

28. The method of claim 21, wherein the low molecular weight high density polyethylene has a weight-average molecular weight of between about 1,000 g/mol and 60,000 g/mol.

29. The method of claim 21, wherein the low molecular weight high density polyethylene has a weight-average molecular weight of between about 10,000 g/mol and 60,000 g/mol.

30. The method of claim 21, wherein the higher molecular weight high density polyethylene has a weight-average molecular weight of between about 50,000 g/mol and 350,000 g/mol.

31. The method of claim 21, wherein the higher molecular weight high density polyethylene has a weight-average molecular weight of between about 50,000 g/mol and 200,000 g/mol.

32. A packaging article, comprising:
at least one layer comprising between about 1 wt % and 30 wt % of a low molecular weight high density polyethylene and between about 99 wt % and 70 wt % of a higher molecular weight high density polyethylene, wherein the low molecular weight high density polyethylene has a weight-average molecular weight between about 1,000 g/mol and 100,000 g/mol, and the higher molecular weight high density polyethylene molecular weight high density polyethylene has a weight-average molecular weight (1) that is between about 50,000 g/mol and 500,000 g/mol and (2) that is higher than the weight-average molecular weight of the low molecular weight high density polyethylene, wherein the layer has a normalized MVTR of less than about 0.41 g/100 in²·day·mil.

33. The packaging article of claim 32, wherein the layer has a normalized MVTR of less than about 0.37 g/100in²·day·mil.

34. The packaging article of claim 32, wherein the layer has a normalized MVTR of less than about 0.33 g/100 in²·day·mil.

35. The packaging article of claim 32, wherein the layer consists essentially of the low molecular weight high density polyethylene and the higher molecular weight high density polyethylene.

36. The packaging article of claim 32, wherein the layer consists essentially of at least one antioxidant, low molecular weight high density polyethylene, and the higher molecular weight high density polyethylene.

37. The packaging article of claim 32, wherein the layer comprises between about 1 wt % and 20 wt % of the low molecular weight high density polyethylene.

38. The packaging article of claim 32, wherein the layer comprises between about 10 wt % and 20 wt % of the low molecular weight high density polyethylene.

39. The packaging article of claim 32, wherein the low molecular weight high density polyethylene has a weight-average molecular weight of between about 1,000 g/mol and 60,000 g/mol.

40. The packaging article of claim 32, wherein the low molecular weight high density polyethylene has a weight-average molecular weight of between about 10,000 g/mol and 60,000 g/mol.

41. The packaging article of claim 32, wherein the low molecular weight high density polyethylene has a density that is greater than or equal to the density of the higher molecular weight high density polyethylene.

42. The packaging article of claim 32, wherein the low molecular weight high density polyethylene has a zero-shear viscosity that is less than or equal to about 0.9 times the zero-shear viscosity of the higher molecular weight high density polyethylene.

43. The packaging article of claim 32, wherein the higher molecular weight high density polyethylene has a weight-average molecular weight of between about 50,000 g/mol and 350,000 g/mol.

44. The packaging article of claim 32, wherein the higher molecular weight high density polyethylene has a weight-average molecular weight of between about 50,000 g/mol and 200,000 g/mol.

45. The packaging article of claim 32, wherein the layer comprises at least about 100 ppm of at least one primary antioxidant.

46. The packaging article of claim 45, wherein the layer further comprises at least one secondary antioxidant.

47. The packaging article of claim 32, wherein the article is a film.

48. The packaging article of claim 47, wherein the film is a blown film or a cast film.

49. The packaging article of claim 32, wherein the layer is a coating or a laminate.
